(19) United States
(12) Patent Application Publication
(10) Pub. No.: US 2023/0378516 A1
(43) Pub. Date: Nov. 23, 2023

(54) BATTERY PROCESSING METHOD

(71) Applicant: TOYOTA JIDOSHA KABUSHIKI KAISHA, Toyota-shi Aichi-ken (JP)

(72) Inventors: Keisuke ISOMURA, Kariya-shi Aichi-ken (JP); Kenichiro MURAMATSU, Toyota-shi Aichi-ken (JP)

(73) Assignee: TOYOTA JIDOSHA KABUSHIKI KAISHA, Toyota-shi Aichi-ken (JP)

(21) Appl. No.: 18/197,372

(22) Filed: May 15, 2023

(30) Foreign Application Priority Data
May 17, 2022 (JP) 2022-080848

(51) Int. Cl. H01M 10/04

(52) U.S. Cl. CPC H01M 10/0468

(57) ABSTRACT

A battery processing method comprises: a preparation step to prepare a pulverized piece including an electrode substrate and an active material layer, the active material layer including a resin component and being provided on the electrode substrate; a heating step to heat the pulverized piece at a temperature not lower than a degradation starting temperature of the resin component and lower than a degradation peak temperature of the resin component; and a pulverization step to pulverize the pulverized piece, wherein in the heating step, the resin component is softened, and, in the pulverization step, the pulverized piece in a state where the resin component has been softened is pulverized and thereby the active material layer is peeled from the electrode substrate.

### CROSS REFERENCE TO RELATED APPLICATIONS

This nonprovisional application claims priority to Japanese Patent Application No. 2022-080848 filed on May 17, 2022, with the Japan Patent Office, the entire contents of which are hereby incorporated by reference.

### BACKGROUND

### Field

The present disclosure relates to a battery processing method that involves peeling an active material layer from an electrode substrate.

### Description of the Background Art

Secondary batteries that comprise a case accommodating both an electrolyte solution and a battery element are widely used as a power source for electronic devices such as video cameras, laptop personal computers, and mobile phones, electric vehicles, and hybrid electric vehicles, among others. Therefore, collecting recyclable material such as valuable metals from used secondary batteries, discarded unused secondary batteries, or the like is taken very seriously from the viewpoint of effective utilization of resources.

As a method of battery processing for collecting recyclable material such as valuable metals, Japanese Patent Laying-Open No. 2012-195073 discloses a method that involves pulverizing a secondary battery to remove a separator and, then, heating the pulverized piece including an electrode substrate and an active material layer at a temperature within the range of 400° C. to 550° C., followed by further pulverizing the pulverized piece thus heated.

### SUMMARY

However, in the battery processing method disclosed by Japanese Patent Laying-Open No. 2012-195073, for the purpose of degrading the binder included in the active material layer, heating is carried out at 400° C. to 550° C., and thereby a great amount of thermal energy is consumed. In addition, this method degrades a large amount of binder and therefore tends to emit carbon dioxide. Thus, it imposes a great burden on the environment.

The present disclosure has been devised in light of the above-described problems, and an object of the present disclosure is to provide a battery processing method that is capable of peeling an active material layer from an electrode substrate with reduced environmental burdens.

A battery processing method according to the present disclosure comprises: a preparation step to prepare a pulverized piece including an electrode substrate and an active material layer, the active material layer including a resin component and being provided on the electrode substrate; a heating step to heat the pulverized piece at a temperature not lower than a degradation starting temperature of the resin component and lower than a degradation peak temperature of the resin component; and a pulverization step to pulverize the pulverized piece. In the heating step, the resin component is softened, and, in the pulverization step, the pulverized piece in a state where the resin component has been softened is pulverized and thereby the active material layer is peeled from the electrode substrate.

With the above-described configuration, the pulverized piece is heated at a temperature not lower than the degradation starting temperature of the resin component and lower than the degradation peak temperature of the resin component, and, as a result, the resin component can be softened at a low temperature with reduced thermal energy consumption. In addition, degradation of the resin component can be reduced, and, as a result, carbon dioxide emission can also be reduced. Further, because the pulverized piece is pulverized in a state where the resin component has been softened, the active material layer can be peeled from the electrode substrate. In this way, peeling of the active material layer from the electrode substrate can be achieved with reduced environmental burdens.

In the battery processing method according to the present disclosure, fragments of the electrode substrate from which the active material layer has been peeled may have a particle area from 400 mm² to 1000 mm² when the fragments are spread flatly, and a rate of peeling of the active material layer from the electrode substrate may be 80% or more.

With the above-described configuration, even when the fragments of the electrode substrate from which the active material layer has been peeled is relatively large, the active material layer can be efficiently peeled from the electrode substrate.

In the battery processing method according to the present disclosure, the heating step and the pulverization step may be carried out at the same time.

With the above-described configuration, because heating and pulverization are carried out at the same time, it is not necessary to transfer, after heating, the heated pulverized piece to the pulverization step, making the processing simpler.

In the battery processing method according to the present disclosure, the heating step and the pulverization step may be carried out repeatedly.

With the above-described configuration, the resin component included in the active material layer adhered to the fragments of the pulverized electrode substrate can be further softened, and thereby the active material layer can be further peeled from the fragments of the electrode substrate.

In some embodiments, the battery processing method according to the present disclosure, in the preparation step, the pulverized piece thus prepared includes a separator, and in the pulverization step, the separator, the electrode substrate, and the active material layer are separated from each other.

With the above-described configuration, the pulverized piece can be heated at a low temperature, and, as a result, melting and sticking of the separator to the active material layer can be prevented, and, even when the pulverized piece includes a separator, the active material layer can be separated from the electrode plate. Therefore, it is not necessary to remove the separator in advance, making the processing simpler.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a flowchart illustrating steps of a battery processing method according to Embodiment 1.

FIG. 2 is a schematic view of a heating step to heat a pulverized piece according to Embodiment 1.

FIG. 3 is a schematic view of a pulverization step according to Embodiment 1.

FIG. 4 is a schematic view illustrating a battery processing method according to a modification where a heating step to heat a pulverized piece and a pulverization step to pulverize the same are carried out at the same time.

FIG. 5 is a flowchart illustrating steps of a battery processing method according to Embodiment 2.

FIG. 6 shows conditions and results of an experiment performed by using a battery processing method according to Example and a battery processing method according to Comparative Example.

FIG. 7 is a plot showing a relationship between a particle area and a rate of peeling in each of Comparative Examples 1 to 8 and Examples 1 to 2 shown in FIG. 6.

### DETAILED DESCRIPTION

A detailed description will be given of embodiments of the present disclosure, with reference to drawings. In the embodiments described below, the same or common members are denoted by the same reference numeral in the drawings, and description thereof will not be repeated.

### Embodiment 1

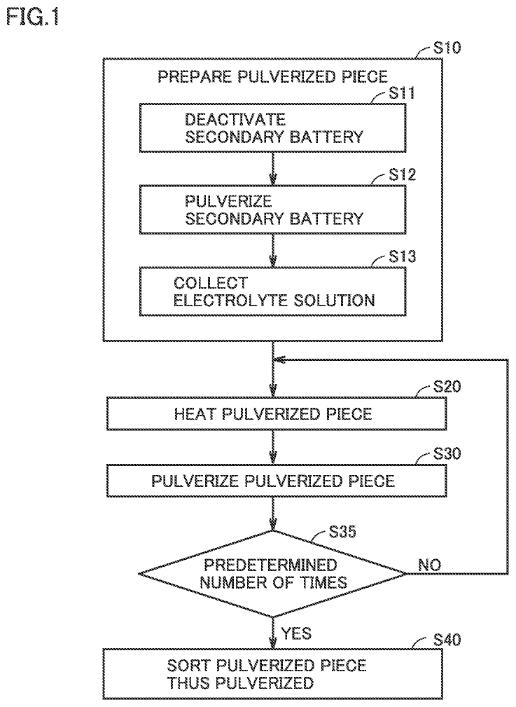

FIG. 1 is a flowchart illustrating steps of a battery processing method according to Embodiment 1. The battery processing method according to Embodiment 1 is described below with reference to FIG. 1.

The battery processing method according to Embodiment 1 is a method to be used for collecting an active material layer that includes a valuable metal and/or the like.

The battery to be processed by the battery processing method is a secondary battery such as, for example, a lithium-ion battery. The secondary battery includes a battery element, an electrolyte solution, and an exterior case accommodating the battery element and the electrolyte solution.

The battery element is formed by stacking a positive electrode and a negative electrode, with a separator interposed between them.

The positive electrode includes a sheet-form member as an electrode substrate, as well as a positive electrode active material layer. The sheet-form member is made of metal foil such as aluminum foil, for example. The positive electrode active material layer may be formed on both sides of the sheet-form member. The positive electrode active material layer includes a positive electrode active material, as well as a binder which is a resin component.

The positive electrode active material is typically a lithium (Li) containing metal oxide. Specifically, the positive electrode active material is of lithium-cobalt oxide type, lithium-manganese oxide type, and/or lithium-nickel-cobalt-manganese oxide type, for example.

The binder may be carboxymethylcellulose (CMC), styrene-butadiene rubber (SBR), polyacrylic acid (PAA), and/or the like, for example.

The negative electrode includes a sheet-form member and a negative electrode active material layer. The sheet-form member is made of metal foil such as copper foil, for example. The negative electrode active material layer may be formed on both sides of the sheet-form member.

The negative electrode active material layer includes a negative electrode active material and a binder. For example, the negative electrode active material may be a carbon-based negative electrode active material such as graphite, soft carbon, and/or hard carbon, or may be an alloy-based negative electrode active material containing silicon (Si), tin (Sn), and/or the like.

Similarly to the above description, the binder may be, for example, carboxymethylcellulose (CMC), styrene-butadiene rubber (SBR), polyacrylic acid (PAA), and/or the like.

The separator is an electrically-insulating porous film. The separator is made of a resin such as polyethylene (PE) and polypropylene (PP), for example. The separator may be made of a PE porous film alone, or the separator may be made of a combination of a PE porous film and a PP porous film. For example, the separator may be formed by stacking a PP porous film, a PE porous film, and a PP porous film in this order. For example, the separator may be formed by stacking a porous PE film and a porous PP film.

As the electrolyte solution, a lithium salt such as lithium hexafluorophosphate (LiPF₆) dissolved in a mixed solvent such as ethylene carbonate (EC)-dimethyl carbonate (DMC) may be used, for example, but those of other compositions may also be used. The exterior case is made of metal such as aluminum, for example.

As illustrated in FIG. 1, for implementing the battery processing method according to Embodiment 1, firstly, a pulverized piece is prepared in a step (S10).

For implementing the step (S10), firstly, the secondary battery is deactivated in a step (S11). Specifically, discharging and/or the like is performed to reduce the voltage of the secondary battery to be equal to or less than a predetermined value so that the battery loses its function as a battery.

Subsequently, in a step (S12), the secondary battery is pulverized. For example, the secondary battery may be crushed with the use of a uniaxial shear crushing machine, a biaxial shear crushing machine, or the like, or the secondary battery may be crushed with the use of a hammer mill or other crushing machines.

Subsequently, in a step (S13), the electrolyte solution is collected. Specifically, the pulverized piece resulting from the step (S12) is heated under reduced pressure to distill the electrolyte solution. At this time, a solvent contained in the electrolyte solution having a relatively low boiling point from about 90° C. to about 110° C., such as DMC and/or EMC (ethyl methyl carbonate), is readily collected, and a solvent contained in the electrolyte solution having a relatively high boiling point of about 240° C., such as EC, may remain without being collected.

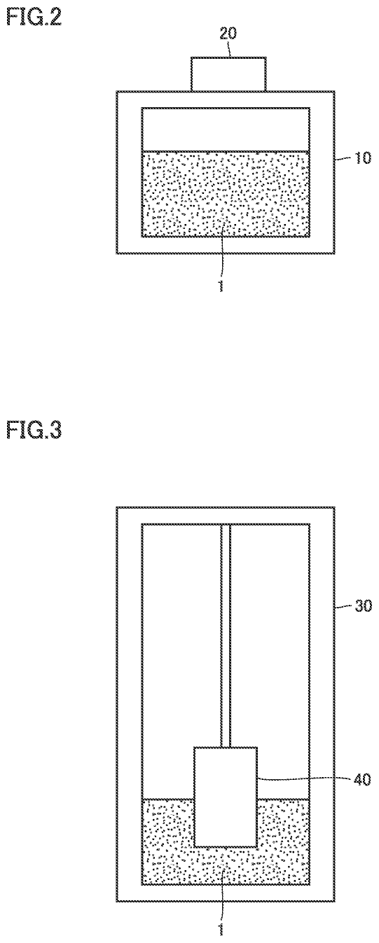

By the above-described steps, a pulverized piece 1 including the sheet-form member, and also including the active material layer that includes the binder and is provided on the sheet-form member (see FIG. 2) is prepared. More specifically, pulverized piece 1 including the positive electrode active material and a sheet member intended for positive electrode use is prepared. Pulverized piece 1 may include a separator. In Embodiment 1, pulverized piece 1 thus prepared is a primary pulverized piece which is a pulverized product of the secondary battery.

FIG. 2 is a schematic view of a heating step to heat a pulverized piece according to Embodiment 1. As illustrated in FIG. 1 and FIG. 2, subsequently, in a step (S20), pulverized piece 1 is heated at a temperature not lower than the degradation starting temperature of the binder and lower than the degradation peak temperature of the binder. The degradation starting temperature of the binder is about 120° C., for example, and the degradation peak temperature of the binder is about 400° C., for example.

In the step (S20), for the purpose of softening the binder with a relatively low thermal energy, in some embodiments, the temperature range for heating the pulverized piece is from about 120° C. to about 180° C. When the pulverized piece includes a separator, for the purpose of inhibiting the melting of the separator, in some embodiments, the temperature range is from about 120° C. to about 160° C. or from about 120° C. to about 140° C. In some embodiments, when pulverized piece 1 includes a separator, heat pulverized piece 1 is heated at a temperature not lower than the degradation starting temperature of the binder and not higher than the melting point of the separator.

At the time of heating pulverized piece 1, pulverized piece 1 is placed in a heating chamber 10 and pulverized piece 1 is heated with the use of a heat source 20 such as a heater, for example. Heating pulverized piece 1 is not limited to heating with a heater, and an appropriate heating mode such as convection heating, far-infrared heating, and/or steam heating may be adopted. The heating duration is about one hour, for example.

When pulverized piece 1 is heated at a temperature within the above-described range, the binder is softened and, as a result, the active material layer is readily separated from the sheet-form member.

FIG. 3 is a schematic view of a pulverization step according to Embodiment 1. As illustrated in FIG. 1 and FIG. 3, subsequently, in a step (S30), pulverized piece 1 thus heated is pulverized. Specifically, pulverized piece 1 thus heated is placed in a pulverization chamber 30 and pulverized piece 1 is pulverized with the use of a pulverization machine 40, for example. As pulverization machine 40, an appropriate pulverization machine such as a hammer crusher can be used. When a hammer crusher is used, greater friction can be applied to pulverized piece 1.

In the step (S30), pulverized piece 1 is pulverized in a state where the binder has been softened, and, as a result, with the impact applied to pulverized piece 1, the active material layer can be peeled from the sheet-form member.

Although the above description is directed to a case where the step (S30) is carried out after the step (S20), the step (S20) and the step (S30) may be carried out at the same time as described in a modification. In such a case, because heating of pulverized piece 1 and pulverization of the same are carried out at the same time, it is not necessary to transfer, after heating pulverized piece 1, the heated pulverized piece 1 to the pulverization step, making the processing simpler.

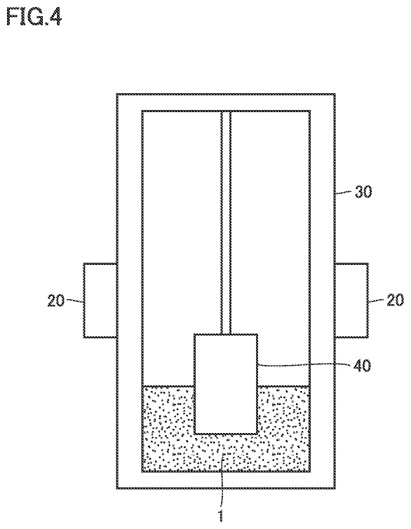

FIG. 4 is a schematic view illustrating a battery processing method according to a modification where a heating step to heat a pulverized piece and a pulverization step to pulverize the same are carried out at the same time. When the heating step to heat a pulverized piece and the pulverization step to pulverize the same are carried out at the same time, heat source 20 such as a heater is placed in pulverization chamber 30, as illustrated in FIG. 4, and pulverized piece 1 is pulverized with pulverization machine 40 while pulverized piece 1 is being heated. Similarly to the above description, heating of pulverized piece 1 is not limited to heating with a heater, and an appropriate heating mode such as convection heating, far-infrared heating, and/or steam heating may be adopted.

Subsequently, in a step (S35), checking is performed for whether or not the step (S20) and the step (S30) were carried out a predetermined number of times. The predetermined number of times may be one, or may be two or more.

When the step (S20) and the step (S30) were carried out the predetermined number of times (step (S35), YES), a step (S40) is carried out.

When the step (S20) and the step (S30) were not carried out the predetermined number of times (step (S35), NO), the step (S20) and the step (S30) are repeated until the predetermined number of times is reached.

When the step (S20) and the step (S30) are thus repeated, the resin component included in the active material layer adhered to the fragments of the pulverized electrode substrate is further softened, and, in that state, the fragments are pulverized, and, as a result, the active material layer can be further peeled from the fragments of the electrode substrate.

Subsequently, in the step (S40), pulverized piece 1 thus pulverized is sorted. Specifically, a sieve and/or the like is used to separate the sheet-form member from the active material layer. At this time, not only the sheet-form member and the active material layer but also the separator, the components of the exterior case, and the like are also separated. The pulverized piece 1 sorted in Embodiment 1 is a secondary pulverized piece resulting from pulverization of the primary pulverized piece, and in the step (S40), this secondary pulverized piece is sorted.

As described above, in the battery processing method according to Embodiment 1, the pulverized piece is heated at a temperature not lower than the degradation starting temperature of the resin component and lower than the degradation peak temperature of the resin component, and, as a result, the resin component included in the active material layer can be softened at a low temperature with reduced thermal energy consumption. In addition, degradation of the resin component can be reduced, and, as a result, carbon dioxide emission can also be reduced. Further, because the pulverized piece is pulverized in a state where the resin component has been softened, the active material layer can be peeled from the electrode substrate. In this way, peeling of the active material layer from the electrode substrate can be achieved with reduced environmental burdens.

In some embodiments, the fragments of the sheet-form member (a sheet-form member intended for positive electrode use) from which the active material layer (more specifically, the positive electrode active material layer) has been peeled have a particle area from 400 mm² to 1000 mm² when the fragments are spread flatly, and the rate of peeling of the active material layer from the sheet-form member is 80% or more.

The particle area of the fragments described above can be calculated in the below manner. Firstly, in the step (S40), a plurality of fragments (particles) of the sheet-form member from which the active material layer has been peeled are sampled, and these fragments of the sheet-form member are spread flatly. Then, the size of the fragments of the sheet-form member thus spread is calculated with the use of image analysis software WinROOF (manufactured by MITANI CORPORATION).

For example, the particle area (mm²) may be obtained by dividing the area (project area) of each particle by the total number of the plurality of particles and then calculating the sum of the values thus obtained. More specifically, it may be calculated by the following equation (1):

Particle area (mm²)=Σᵢ₌₁ⁿ((Particle Xi particle length (mm))×(Particle Xi particle width (mm))/(Total number of plurality (n) of particles)) (Equation 1)

Moreover, the rate of peeling may be determined by calculating the total area of the active material layer remaining on the fragments (particles) of the sheet-form member with the use of the above-mentioned image analysis software and then using the following equation (2).

Rate of peeling (%)=((Total area of plurality (n) of particles)−(Total area of active material layer remaining on plurality (n) of particles))/(Total area of plurality of particles)×100 (Equation 2)

### Embodiment 2

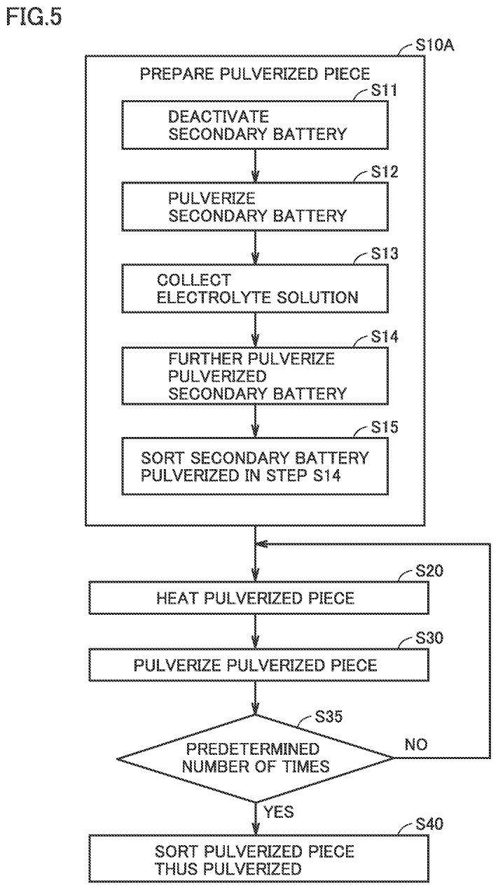

FIG. 5 is a flowchart illustrating steps of a battery processing method according to Embodiment 2. The battery processing method according to Embodiment 2 is described below with reference to FIG. 5.

As illustrated in FIG. 5, the battery processing method according to Embodiment 2 is different from the battery processing method according to Embodiment 1 in terms of a preparation step (S10A) to prepare a pulverized piece. The other steps are substantially the same.

For implementing the battery processing method according to Embodiment 2, firstly, in the step (S10A), a pulverized piece is prepared. For implementing the step (S10A), the step (S11) to the step (S13) are carried out substantially in the same manner as in Embodiment 1.

Subsequently, in the step (S14), the secondary battery thus pulverized is further pulverized. Specifically, the primary pulverized piece resulting from the step (S13) is pulverized. In the step (S14), the primary pulverized piece is pulverized with the use of an appropriate pulverization machine.

Subsequently, in a step (S15), the secondary battery pulverized in the step (S14) is sorted. Specifically, a secondary pulverized piece resulting from pulverization of the primary pulverized piece is sorted. By this, a pulverized piece including the sheet-form member and also including the active material layer that includes the binder and is provided on the sheet-form member is prepared. Hence, the pulverized piece prepared in Embodiment 2 is the sheet member separated from the secondary pulverized piece and provided with the active material layer. In some embodiments, the sheet-form member is a sheet member intended for positive electrode use, and the active material layer is a positive electrode active material layer including a binder. The pulverized piece thus prepared may include the separator.

Subsequently, the step (S20) to the step (S40) are carried out substantially in the same manner as in Embodiment 1. When the battery processing method according to Embodiment 2 is implemented in the above-described manner, substantially the same effect as in Embodiment 1 is obtained. In the step (S20) to the step (S40), as described above, the sheet member provided with the active material layer is used as the pulverized piece, and therefore, by the step (S40), the sheet member is separated from the active material layer.

(Verification Experiment)

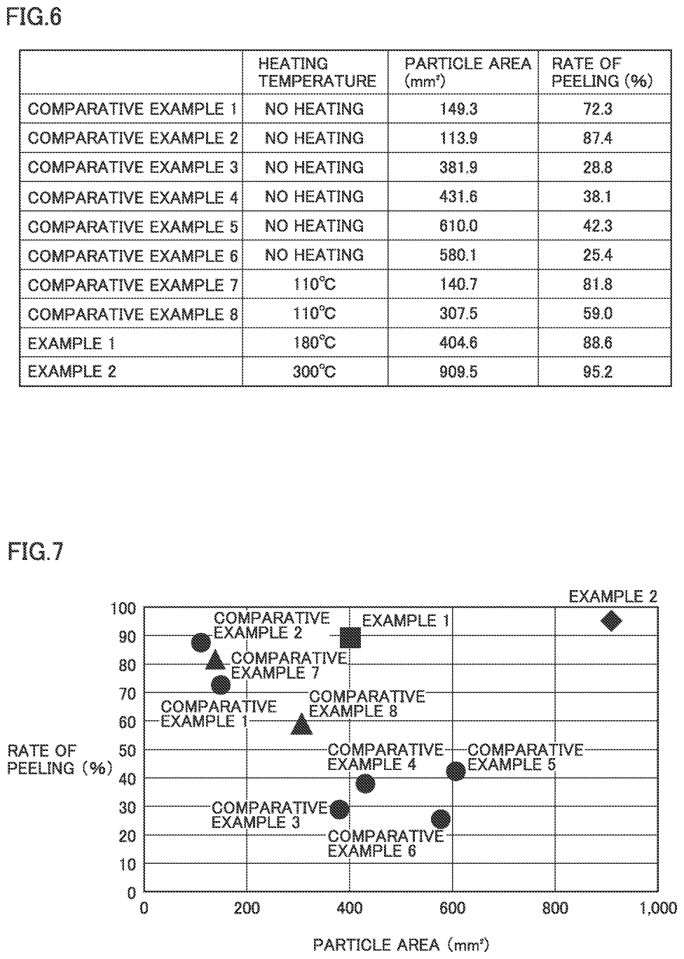

FIG. 6 shows conditions and results of an experiment performed by using a battery processing method according to Example and a battery processing method according to Comparative Example. FIG. 7 is a plot showing a relationship between a particle area and a rate of peeling in each of Comparative Examples 1 to 8 and Examples 1 to 2 shown in FIG. 6. Verification experiment is described below with reference to FIG. 6 and FIG. 7.

As shown in FIG. 6, in Comparative Example 1 to Comparative Example 6, as compared to the above-described steps of the battery processing method according to Embodiment 1, the heating step (S20) was omitted, and the pulverized piece prepared in the preparation step (S10) was pulverized in the pulverization step (S30) without heating. In Comparative Examples 1 to 6, pulverization conditions were changed so that fragments (particles) with different particle areas could be obtained. After pulverization, the sheet-form member (the sheet-form member intended for positive electrode use) was separated from the active material layer (the positive electrode active material) with the use of a sieve and/or the like, and, by the above-described calculation method, the particle area of the fragments of the sheet-form member and the rate of peeling of the active material layer were calculated.

In Comparative Examples 7 and 8, as compared to the above-described steps of the battery processing method according to Embodiment 1, the temperature for heating the pulverized piece in the heating step (S20) was changed to 110° C., which was lower than the degradation starting temperature of the resin component (the binder), and the pulverized piece thus heated at 110° C. was pulverized in the pulverization step (S30). In Comparative Examples 7 and 8, pulverization conditions were changed so that fragments (particles) with different particle areas could be obtained. After pulverization, the sheet-form member was separated from the active material layer with the use of a sieve and/or the like, and, by the above-described calculation method, the particle area of the fragments of the sheet-form member and the rate of peeling of the active material layer were calculated.

In Examples 1 and 2, battery processing was carried out by the above-described steps of the battery processing method according to Embodiment 1. In this case, the temperature for heating the pulverized piece in the heating step (S20) was changed to 180° C. and 300° C. Both temperatures are not lower than the degradation starting temperature of the resin component and lower than the degradation peak temperature of the resin component.

The pulverized piece thus heated at 180° C. and 300° C. was pulverized in the pulverization step (S30). After pulverization, the sheet-form member was separated from the active material layer with the use of a sieve and/or the like, and, by the above-described calculation method, the particle area of the fragments of the sheet-form member and the rate of peeling of the active material layer were calculated.

As shown in FIG. 6 and FIG. 7, when the particle area was equal to or close to 149.3 mm² as in Comparative Example 2, the rate of peeling was equal to or close to 87.4%. However, by the pulverization intended for reducing the particle area, the active material layer was contaminated with the material of the exterior case, copper of the negative electrode, or the like, and separation of the active material layer from them was poor.

When the particle area was increased as in Comparative Examples 1 and 3 to 6 for the purpose of reducing contamination in the active material layer, heating was not carried out and thereby the active material layer was highly sticky, and, as the particle area increased, the rate of peeling tended to be decreased. Specifically, when the particle area exceeded 380 mm², the rate of peeling became below 50%.

When the particle area was equal to or close to 140.7 mm² as in Comparative Example 7, the rate of peeling was equal to or close to 81.8%. However, due to the decreased particle area, the active material layer was contaminated with the material of the exterior case, copper of the negative electrode, or the like, and separation of the active material layer from them was poor.

When the particle area was increased as in Comparative Example 8 for the purpose of reducing contamination in the active material layer, the rate of peeling was lower than in Comparative Example 8, and the rate of peeling was equal to or close to 59.0%.

On the other hand, in Example 1, the particle area was equal to or close to 404.6 mm², and the rate of peeling was 88.6%, which were higher than in Comparative Examples 1 to 8. Similarly, in Example 2, the particle area was equal to or close to 909.5 mm², and the rate of peeling was 95.2%, which were higher than in Comparative Examples 1 to 8.

Moreover, in Examples 1 and 2, the particle area was relatively large, and therefore contamination of the active material layer with the material of the exterior case, copper of the negative electrode, or the like was reduced.

As described above, it was also verified by experiment that, by heating the pulverized piece at a temperature not lower than the degradation starting temperature of the resin component and lower than the degradation peak temperature of the resin component, reducing thermal energy consumption, softening the resin component included in the active material layer at a low temperature, and pulverizing the pulverized piece, the active material layer can be peeled from the sheet-form member with reduced environmental burdens.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A battery processing method comprising:
a preparation step to prepare a pulverized piece including an electrode substrate and an active material layer, the active material layer including a resin component and being provided on the electrode substrate;
a heating step to heat the pulverized piece at a temperature not lower than a degradation starting temperature of the resin component and lower than a degradation peak temperature of the resin component; and
a pulverization step to pulverize the pulverized piece, wherein
in the heating step, the resin component is softened, and
in the pulverization step, the pulverized piece in a state where the resin component has been softened is pulverized and thereby the active material layer is peeled from the electrode substrate.

2. The battery processing method according to claim 1, wherein fragments of the electrode substrate from which the active material layer has been peeled have a particle area from 400 mm² to 1000 mm² when the fragments are spread flatly, and a rate of peeling of the active material layer from the electrode substrate is 80% or more.

3. The battery processing method according to claim 1, wherein the heating step and the pulverization step are carried out at the same time.

4. The battery processing method according to claim 1, wherein the heating step and the pulverization step are carried out repeatedly.

5. The battery processing method according to claim 1, wherein
in the preparation step, the pulverized piece thus prepared includes a separator, and
in the pulverization step, the separator, the electrode substrate, and the active material layer are separated from each other.
